(19) United States
(12) Patent Application Publication
(10) Pub. No.: US 2026/0056489 A1
(43) Pub. Date: Feb. 26, 2026

(54) IMAGE FORMING APPARATUS

(71) Applicant: CANON KABUSHIKI KAISHA, Tokyo (JP)

(72) Inventors: Hiroshi OGURI, Chiba (JP); Satoshi OGAWARA, Chiba (JP)

(21) Appl. No.: 19/303,903

(22) Filed: Aug. 19, 2025

(30) Foreign Application Priority Data
Aug. 22, 2024 (JP) 2024-140649
Aug. 22, 2024 (JP) 2024-140652

(51) Int. Cl. G03G 15/16; G03G 15/00

(52) U.S. Cl. CPC G03G 15/1695; G03G 15/1625; G03G 15/6558; G03G 15/6591; G03G 2215/00409; G03G 2215/00447; G03G 2215/00523

(57) ABSTRACT

An image forming apparatus includes an image bearing member, an image former configured to form an image on the image bearing member, a transfer portion configured to transfer the image formed on the image bearing member onto a recording material, a conveyor configured to convey the recording material to the transfer portion, a contact portion provided upstream of the transfer portion in a conveyance direction of the recording material and having a contact member for grounding the recording material to be conveyed to the transfer portion, and at least one processor configured to control, in a case where the recording material is of a first paper type, the contact portion so that the recording material is grounded by the contact member.

### BACKGROUND

### Field of the Technology

The present disclosure relates to an image forming apparatus such as a printer, a copying machine, and a multifunction peripheral.

### Description of the Related Art

An electrophotographic apparatus, an electrostatic recording apparatus, or a similar image forming apparatus develops an electrostatic latent image formed on a photosensitive drum, to thereby form a toner image. The toner image is transferred onto a recording material. The transfer onto a recording material is performed directly from the photosensitive drum, or indirectly from the photosensitive drum via an intermediate transfer belt. The case of indirect transfer via an intermediate transfer belt is described here.

A transfer unit for transferring a toner image from the intermediate transfer belt onto a recording material includes a transfer inner roller provided inside the intermediate transfer belt and a transfer outer roller provided outside the intermediate transfer belt. At the time of the transfer, a predetermined bias voltage is applied to the transfer inner roller. The bias voltage is controlled by constant-voltage control so as to be constant during the transfer. Through the constant-voltage control, a current flowing to the recording material during the transfer is adjusted to a constant current.

Metalized paper including a metal layer is sometimes used as the recording material. Stable transfer of a toner image is desired for metalized paper as well. However, compared to a recording material that is paper without a metal layer, metalized paper is high in conductivity and low in impedance. For that reason, a current flowing to metalized paper is unstable despite the transfer unit being under constant-voltage control, and stable transfer of a toner image to metalized paper is consequently difficult in some cases. In Japanese Patent Application Laid-open No. 2018-60072, there is disclosed an image forming apparatus that causes a stable current to flow to metalized paper during the transfer. This image forming apparatus grounds a recording material by providing a contact member in the vicinity of the transfer unit and bringing the recording material into contact with the contact member. Owing to the contact member, a current path that has not been required in the related art is actively formed to stabilize a current flowing to the recording material. The toner image is accordingly transferred in a favorable manner.

The image forming apparatus may form an image on a recording material other than metalized paper, such as thin paper which has a light basis weight. The transfer unit uses the transfer inner roller and the transfer outer roller to convey the recording material in a nipped state during the transfer. A recording material that has a light basis weight is lighter in self-weight than a recording material that has a heavy basis weight, and may consequently be warped at a rear end of the recording material by being nipped between the transfer inner roller and the transfer outer roller. This warping causes the recording material that has a light basis weight to break contact with the contact member at the time of the transfer. The breaking of the contact of the recording material with the contact member changes a current flowing in the transfer unit, and the change may cause a failure to transfer the toner image stably.

Thus, the contact member provided in the vicinity of the transfer unit is effective for stable transfer of the toner image onto a recording material that has low impedance such as metalized paper, but is unsuitable for stable transfer of the toner image onto a recording material that has a light basis weight such as thin paper. For that reason, an image forming apparatus that stably transfers a toner image irrespective of a paper type and the basis weight of a recording material is wanted.

### SUMMARY

An image forming apparatus according to some embodiments of the present disclosure includes an image bearing member, an image former configured to form an image on the image bearing member, a transfer portion configured to transfer the image formed on the image bearing member onto a recording material, a conveyor configured to convey the recording material to the transfer portion, a contact portion provided upstream of the transfer portion in a conveyance direction of the recording material and having a contact member for grounding the recording material to be conveyed to the transfer portion, and at least one processor configured to control, in a case where the recording material is of a first paper type, the contact portion so that the recording material is grounded by the contact member, and control, in a case where the recording material is of a second paper type higher in impedance than the first paper type, the contact portion so as to avoid grounding the recording material.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of an image forming apparatus.

FIG. 2 is an explanatory diagram of a configuration of a pre-transfer contact unit.

FIG. 3 is a view of a secondary transfer unit viewed from a side of a secondary transfer inner roller.

FIG. 4 is an explanatory diagram of a switching unit.

FIG. 5 is an explanatory diagram of metalized paper.

FIGS. 6A and 6B are explanatory diagrams of a phenomenon in which a passing portion current is unstable.

FIG. 7 is a flow chart for illustrating processing in image forming.

FIGS. 8A and 8B are explanatory diagrams of currents in transfer of toner images onto a recording material.

FIG. 9 is a flow chart for illustrating a variation of the processing in image forming.

FIG. 10 is a configuration diagram of another image forming apparatus.

FIG. 11 is an explanatory diagram of a configuration of another pre-transfer contact unit.

FIGS. 12A and 12B are explanatory diagrams of another switching unit.

FIG. 13 is a flow chart for illustrating another variation of the processing in image forming.

FIG. 14 is a flow chart for illustrating still another variation of the processing in image forming.

### DESCRIPTION OF THE EMBODIMENTS

Now, referring to the accompanying drawings, description is given of various exemplary preferred embodiments, features, and aspects of the present disclosure.

### First Embodiment

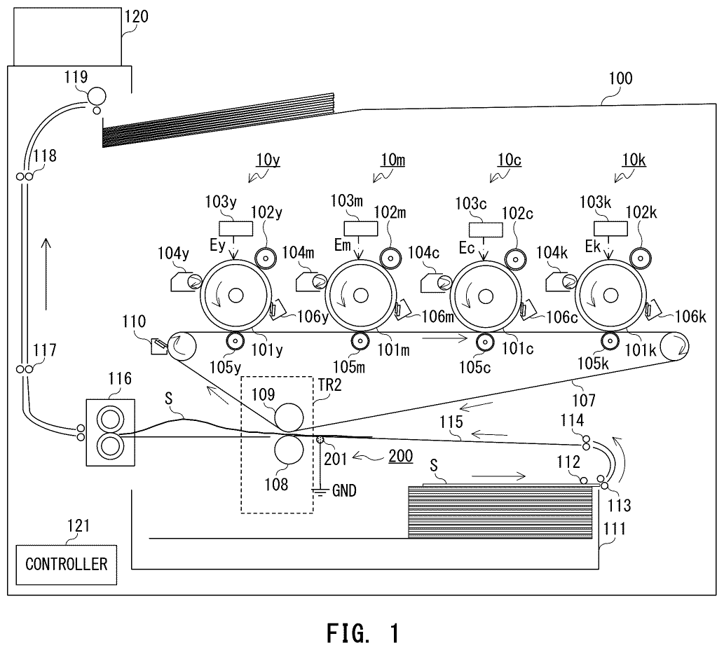

FIG. 1 is a configuration diagram of an image forming apparatus according to a first embodiment of the present disclosure. An image forming apparatus 100 according to the first embodiment includes four image forming units. A first image forming unit 10y forms a yellow image, a second image forming unit 10m forms a magenta image, a third image forming unit 10c forms a cyan image, and a fourth image forming unit 10k forms a black image. The image forming units 10y, 10m, 10c, and 10k are the same as one another in configuration, except for the color of a toner used as a developer.

In FIG. 1, “y” at a tail end of a reference symbol indicates a component for forming a yellow image, “m” at a tail end of a reference symbol indicates a component for forming a magenta image, “c” at a tail end of a reference symbol indicates a component for forming a cyan image, and “k” at a tail end of a reference symbol indicates a component for forming a black image. Here, a configuration of the first image forming unit 10y which forms a yellow image is described, and a description on the configuration of the second, third, and fourth image forming units 10m, 10c, and 10k which form images of other colors is omitted.

The first image forming unit 10y includes a photosensitive drum 101y, a charging roller 102y, an exposure device 103y, a developing device 104y, a primary transfer roller 105y, and a photosensitive member cleaner 106y. The photosensitive drum 101y is a first image bearing member which is rotated in a direction of the arrow and which has a surface charged uniformly to a predetermined polarity and potential by the charging roller 102y. The exposure device 103y scans the charged surface of the photosensitive drum 101y with laser light Ey, which is modulated based on image data representing an image to be formed. An electrostatic latent image is thus formed on the surface of the photosensitive drum 101y. The developing device 104y develops the electrostatic latent image with use of a yellow toner to form a toner image on the surface of the photosensitive drum 101y.

Similarly, a magenta toner image is formed on a photosensitive drum 101m of the second image forming unit 10m. A cyan toner image is formed on a photosensitive drum 101c of the third image forming unit 10c. A black toner image is formed on a photosensitive drum 101k of the fourth image forming unit 10k.

An intermediate transfer belt 107 which is a second image bearing member is placed below the first to fourth image forming units 10y, 10m, 10c, and 10k. The intermediate transfer belt 107 is driven to rotate by a secondary transfer inner roller 109 which functions as a drive roller. A secondary transfer outer roller 108 is provided at a position that faces the secondary transfer inner roller 109 across the intermediate transfer belt 107. The secondary transfer inner roller 109 and the secondary transfer outer roller 108 form a secondary transfer unit TR2. An intermediate transfer belt cleaner 110 is placed on a side upstream of the first image forming unit 10y in a rotation direction of the intermediate transfer belt 107.

The toner images formed on the photosensitive drums 101y, 101m, 101c, and 101k, respectively, are transferred onto the intermediate transfer belt 107 on top of each other by the primary transfer roller 105y and primary transfer rollers 105m, 105c, and 105k, in time with the rotation of the intermediate transfer belt 107. Toners remaining on the photosensitive drums 101y, 101m, 101c, and 101k after the transfer are removed by the photosensitive member cleaner 106y and photosensitive member cleaners 106m, 106c, and 106k. The toner images transferred onto the intermediate transfer belt 107 are conveyed by the rotation of the intermediate transfer belt 107 to a side of the secondary transfer inner roller 109.

The image forming apparatus 100 includes a sheet feeding cassette 111 which stores a recording material S such as a sheet of paper on which an image is to be formed. In order to convey the recording material S stored in the sheet feeding cassette 111 to a conveyance path, the image forming apparatus 100 includes a guide member 115, a pickup roller 112, a sheet feeding roller pair 113, a registration roller pair 114, conveyance roller pairs 117 and 118, and a delivery roller 119. The pickup roller 112 feeds the recording material S stored in the sheet feeding cassette 111 to the conveyance path. The sheet feeding roller pair 113 separates sheets of the recording material S fed by the pickup roller 112 from one another and conveys one sheet at a time to the registration roller pair 114. The registration roller pair 114 corrects skewing of the recording material S. The registration roller pair 114 conveys the recording material S to the secondary transfer unit TR2 via the guide member 115, in time with conveyance of the toner images which have been transferred onto the intermediate transfer belt 107 to the secondary transfer unit TR2.

A pre-transfer contact unit 200 including a contact member 201 is provided on a side upstream of the secondary transfer unit TR2 in a conveyance direction of the recording material S. Details of the pre-transfer contact unit 200 are described later.

The toner images of four colors borne on the intermediate transfer belt 107 are transferred onto the recording material S that is passing through a space between the secondary transfer inner roller 109 and the secondary transfer outer roller 108. A high voltage (bias voltage) of a predetermined level is applied to one of the secondary transfer inner roller 109 and the secondary transfer outer roller 108 to transfer the toner images from the intermediate transfer belt 107 onto the recording material S. Toners remaining on the intermediate transfer belt 107 after the transfer are scraped off and collected by the intermediate transfer belt cleaner 110.

The image forming apparatus 100 includes a fixing device 116 which fixes the toner images to the recording material S. The recording material S with the toner images transferred thereto is conveyed to the fixing device 116 by the secondary transfer outer roller 108. The fixing device 116 fixes the toner images to the recording material S by applying heat and pressure. The recording material S with the toner images fixed thereto is delivered to an outside of the image forming apparatus 100 via the conveyance roller pairs 117 and 118 and the delivery roller 119. The recording material S on which a color image has been formed (a deliverable) is thus obtained.

The image forming apparatus 100 is provided with a controller 121 for controlling operation of the above-mentioned components. The controller 121 includes at least one processor, such as a CPU (Central Processing Memory), and a memory. The image forming apparatus 100 also includes, as a user interface including an input interface and an output interface, an operation unit 120. The operation unit 120 includes various keys or a touch panel as the input interface. The operation unit 120 includes a display and a speaker as the output interface. The controller 121 receives a user's instruction from the operation unit 120, or from an external apparatus via a network (not shown). When receiving a command of a print job (an image forming command), the controller 121 controls operation of the components as described above to execute operation (image forming operation) of printing on the recording material S.

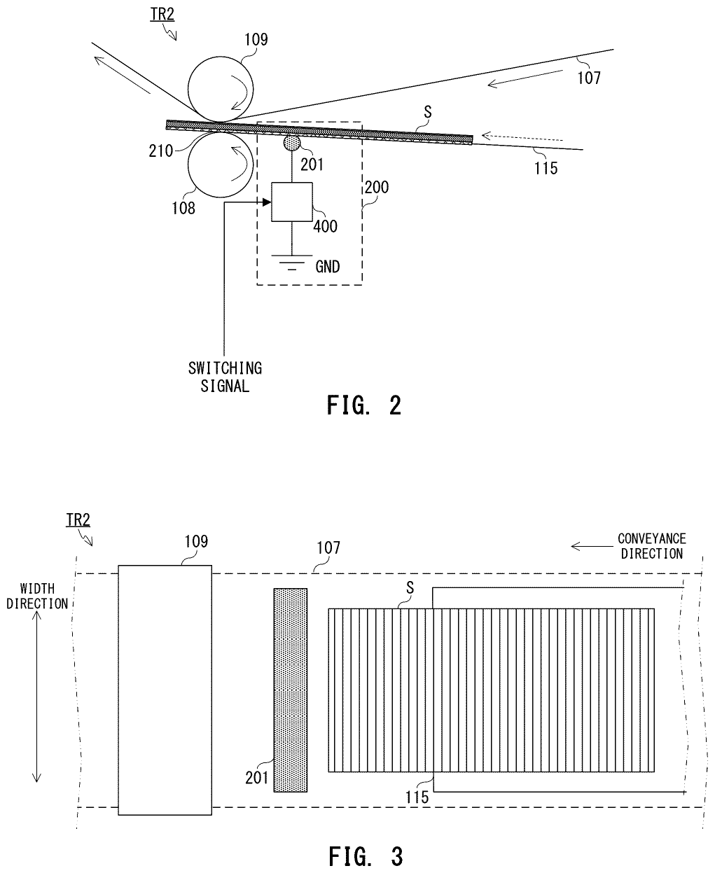

FIG. 2 is an explanatory diagram of a configuration of the pre-transfer contact unit 200. The solid line arrows of FIG. 2 indicate a rotation direction of the intermediate transfer belt 107 and rotation directions of the secondary transfer outer roller 108 and the secondary transfer inner roller 109 in transfer of the toner images onto the recording material S. The broken line arrow indicates a conveyance direction of the recording material S.

The pre-transfer contact unit 200 includes the contact member 201 and a switching unit 400. The contact member 201 is a conductive member, and is placed so as to come into contact with one surface (a surface on an opposite side from a surface onto which the toner images are to be transferred) of the recording material S having been conveyed on the guide member 115. The contact member 201 is grounded via the switching unit 400. The switching unit 400 is a switch device which switches a grounding state (grounded/ungrounded) of the contact member 201 based on a switching signal input from the controller 121. A detailed configuration of the switching unit 400 is described later. The contact member 201 is placed so as to be in contact with the recording material S in one or more places in a case where the recording material S comes into contact with the secondary transfer outer roller 108.

The secondary transfer outer roller 108 and the secondary transfer inner roller 109 of the secondary transfer unit TR2 form a nip portion 210. In the nip portion 210, the intermediate transfer belt 107 and the recording material S are conveyed in a nipped state at the time of the transfer. In the first embodiment, a bias voltage having a potential of the same polarity as that of the toners (a negative potential in the first embodiment) is applied to the secondary transfer inner roller 109, to thereby transfer the toner images from the intermediate transfer belt 107 onto the recording material S. The bias voltage is controlled by constant-voltage control in order to stabilize a current flowing to the recording material S during the transfer. In order to prevent an electric discharge from occurring between the secondary transfer outer roller 108 and the contact member 201 in a case where the bias voltage is applied to the secondary transfer inner roller 109 at the time of the transfer, the contact member 201 is placed at a predetermined distance or farther from the secondary transfer outer roller 108.

The lengths of the secondary transfer inner roller 108 and the secondary transfer outer roller 109 in the rotational axis direction are longer than the length in a width direction of the recording material S of the maximum size allowed to be conveyed, the width direction being a direction intersecting the conveying direction of the recording material S. Accordingly, there are a current flowing in a part of the nip portion 210 through which the recording material S does not pass (a non-passing portion current) and a current flowing in a part of the nip portion 210 through which the recording material S passes (a passing portion current). A current value of a current flowing in the secondary transfer unit TR2 is a sum value of the non-passing portion current and the passing portion current. A ratio of the non-passing portion current and the passing portion current varies depending on a resistance value which depends on the size and material of the recording material S. Accordingly, with constant-current control that keeps the current flowing in the secondary transfer unit TR2 constant, it is difficult to stabilize the passing portion current. For that reason, constant-voltage control is employed for the secondary transfer unit TR2.

FIG. 3 is a view of the secondary transfer unit TR2 viewed from a side of the secondary transfer inner roller 109. The contact member 201 has a columnar shape, and an axis direction thereof runs along the width direction. In this case, a contact between the contact member 201 and the recording material S is linear in the width direction. In order to suppress fluctuations in load impedance of the secondary transfer unit TR2, the length of the contact member 201 in the width direction is longer than the length of the recording material S of a maximum size allowed to be used in this image forming apparatus (the size A3) in the width direction. This suppresses fluctuations in length of a portion of contact with the recording material S even when the recording material S is conveyed askew in the width direction within an expected range of misregistration amount.

A material of the contact member 201 may be lower in impedance than the guide member 115 and, in the first embodiment, the contact member 201 is formed from, for example, a metal member having conductivity. With this configuration, the load impedance viewed from the secondary transfer unit TR2 can be stabilized irrespective of the location of the recording material S that is being conveyed.

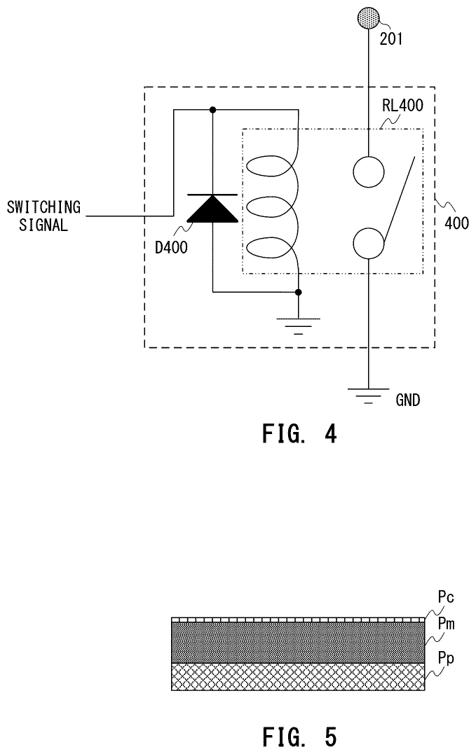

FIG. 4 is an explanatory diagram of the switching unit 400. The switching unit 400 includes a relay RL400 including a switch and a coil, and a commutation diode D400 connected in parallel to the coil of the relay RL400. One end of a coil portion is grounded, and another end of the coil portion is connected to a signal line to which a switching signal is input from the controller 121. One end of the relay RL400 that is on a contact point side is connected to the contact member 201, and another end of the relay RL400 is grounded.

In a case where a switching signal that is at a high level is input to the switching unit 400 from the controller 121, the relay RL400 turns to a conductive state. This grounds the contact member 201, and the recording material S being conveyed through the nip portion 210 is grounded in turn. In a case where the input of the switching signal that is at the high level from the controller 121 stops, the relay RL400 turns to a cutoff state. This brings the contact member 201 to an ungrounded state and, consequently, the recording material S being conveyed through the nip portion 210 is not grounded. A back electromotive force generated in the coil portion of the relay RL400 in a case where the contact point side of the relay RL400 turns to the cutoff state is consumed by impedance of the coil portion through the commutation diode D400.

The thus configured image forming apparatus 100 is effective in a case in which an image is formed on the recording material S that includes a metal layer, such as metalized paper. FIG. 5 is an explanatory diagram of metalized paper. A sectional view of metalized paper is shown in FIG. 5. Metalized paper is generally configured from three layers. The metalized paper in an example of FIG. 5 is configured from three layers that are a plain paper layer Pp, a metal layer, and a coating layer Pc. The metal layer Pm which is the second layer is formed of metal, for example, aluminum, and is deposited by vapor deposition process on the plain paper layer Pp which is the first layer. Being formed of metal, the metal layer Pm is superior in conductivity to the plain paper layer Pp, and is very low in impedance.

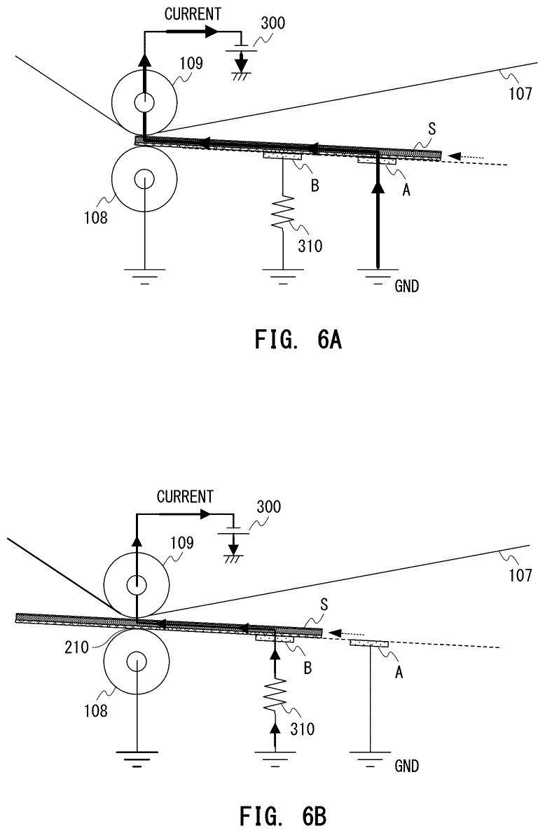

When the metalized paper passes through the nip portion 210, it is known that, even when the secondary transfer unit TR2 is under constant-voltage control, the passing portion current is unstable when the contact member 201 is not provided. FIGS. 6A and 6B are explanatory diagrams of the phenomenon in which the passing portion current is unstable. In FIGS. 6A and 6B, a configuration of an example that lacks the contact member 201 is illustrated, and guide members A and B are provided on a side upstream of the secondary transfer unit TR2 in the conveyance direction of the recording material S. The metalized paper is conveyed to the secondary transfer unit TR2 via the guide members A and B.

The guide member A is configured from a material lower in impedance than the secondary transfer outer roller 108, and is grounded. The guide member B is configured from a member that has predetermined impedance (here, impedance of a resistor 310). The solid line arrows of FIGS. 6A and 6B indicate a path of currents (the non-passing portion current and the passing portion current) flowing in the secondary transfer unit TR2. The broken line arrows indicate the conveyance direction of the recording material S (metalized paper).

FIG. 6A is an illustration of a state in which the front end of the metalized paper has reached the nip portion 210 of the secondary transfer unit TR2. A high voltage (bias voltage) generated by a high-voltage power source 300 is applied to the secondary transfer inner roller 109. The currents flow from the grounded guide member A through the metal layer Pm of the metalized paper to the secondary transfer inner roller 109 because the guide member A is lower in impedance than the secondary transfer outer roller 108.

At this point, load impedance viewed from the secondary transfer unit TR2 is a sum value of impedance of the guide member A, the metalized paper, the intermediate transfer belt 107, and the secondary transfer inner roller 109. That is, the load impedance is a sum value of impedance values given below. Currents depending on the load impedance flow in the secondary transfer unit TR2 because the secondary transfer unit TR2 is under constant-voltage control.
Contact impedance of a place at which the guide member A and the metalized paper are in contact with each other
Longitudinal impedance down the layers of the metalized paper
Contact impedance of a place at which the intermediate transfer belt 107 and the secondary transfer inner roller 109 are in contact with each other
Impedance of the secondary transfer inner roller 109

FIG. 6B is an illustration of a state in which the metalized paper has been conveyed further from the state of FIG. 6A. With the rear end of the metalized paper having passed the guide member A, the metalized paper is no longer in contact with the guide member A. The currents flowing in the secondary transfer unit TR2 accordingly flow from the guide member B, which is grounded via the resistor 310, to the secondary transfer inner roller 109 via the metal layer Pm of the metalized paper. At this point, the load impedance viewed from the secondary transfer unit TR2 is a sum value of the following impedance values.
Impedance of the resistor 310 of the guide member B
Contact impedance of a place at which the guide member B and the metalized paper are in contact with each other
Longitudinal impedance down the layers of the metalized paper
Contact impedance of a place at which the intermediate transfer belt 107 and the secondary transfer outer roller 108 are in contact with each other
Impedance of the secondary transfer inner roller 109

Currents depending on the load impedance flow in the secondary transfer unit TR2 because the secondary transfer unit TR2 is under constant-voltage control. The load impedance of FIG. 6B has involvement of the resistor 310 of the guide member B as compared to the load impedance of FIG. 6A. The passing portion current accordingly decreases. Through this mechanism, the passing portion current flowing in the toners fluctuates with variations in which member is in contact with the metalized paper depending on a location to which the metalized paper is conveyed. This results in a failure to maintain transfer properties of the toner images, and the failure leads to defective transfer. Accordingly, in the first embodiment, the transfer properties of the toner images are maintained by providing the contact member 201 between the guide member B and the secondary transfer outer roller 108 and thus stabilizing the currents flowing to the recording material S.

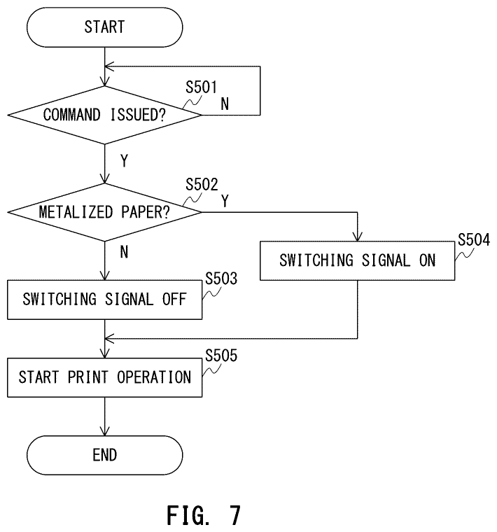

FIG. 7 is a flow chart for illustrating processing in image forming. This processing is for transferring the toner images onto the recording material S without causing defective transfer irrespective of the paper type of the recording material S.

As the image forming apparatus 100 starts to operate, the controller 121 checks whether a command of a print job has been acquired from the operation unit 120 of the image forming apparatus 100, or from an external apparatus via a network (Step S501). In a case where the command has not been acquired (Step S501: N), the controller 121 stands by until the command is acquired.

In a case where the command has been acquired (Step S501: Y), the controller 121 checks a paper type of the recording material S that is stored in the sheet feeding cassette 111 and that is specified in the print job, and determines whether the recording material S is metalized paper (Step S502) or not. The paper type of the recording material S is checked by referring to setting values that are set by the user with use of the operation unit 120 in a case where the recording material S is stored in the sheet feeding cassette 111. The setting values include, for example, feature information (paper type, size, and the like) of the recording material S.

In a case in which the recording material S is a recording material that is not metalized paper and that has high impedance, for example, plain paper (Step S502: N), the controller 121 turns off the switching signal to the switching unit 400 (i.e., the switching signal is not output) (Step S503). In a case in which the recording material S is metalized paper which is low in impedance (Step S502: N), the controller 121 turns on the switching signal to the switching unit 400 (the switching signal is output) (Step S504). The output of the switching signal to the switching unit 400 establishes conduction for the switching unit 400, with the result that the contact member 201 is grounded. After controlling the switching unit 400, the controller 121 starts print operation in order to form an image in accordance with the print job (Step S505). When print operation instructed by the print job is finished, the controller 121 ends a series of processing steps in image forming that is suited to the print job.

The image forming apparatus 100 according to the first embodiment thus switches the grounding state of the contact member 201 within the pre-transfer contact unit 200 between grounded and ungrounded depending on the paper type of the recording material S. Specifically, the contact member 201 is grounded in a case where the recording material S is of a first paper type (for example, metalized paper), and is ungrounded in a case where the recording material S is of a second paper type (other than metalized paper) higher in impedance than the first paper type. Accordingly, in a case where the recording material S is metalized paper, a current flows in the contact member 201 to suppress fluctuations of the passing portion current. In a case where the recording material S is other than metalized paper, currents flow in the secondary transfer outer roller 108 to suppress fluctuations of the passing portion current. With fluctuations of the passing portion current thus suppressed, stable transfer of the toner images is achieved irrespective of the paper type of the recording material S that is passed through.

### Modification Example of First Embodiment

The example described above has a configuration in which fluctuations of the passing portion current are suppressed by switching settings about whether to ground the contact member 201 depending on the paper type of the recording material S. In this example, fluctuations of the passing portion current are suppressed by switching settings about whether to ground the contact member 201 depending on a basis weight of the recording material S.

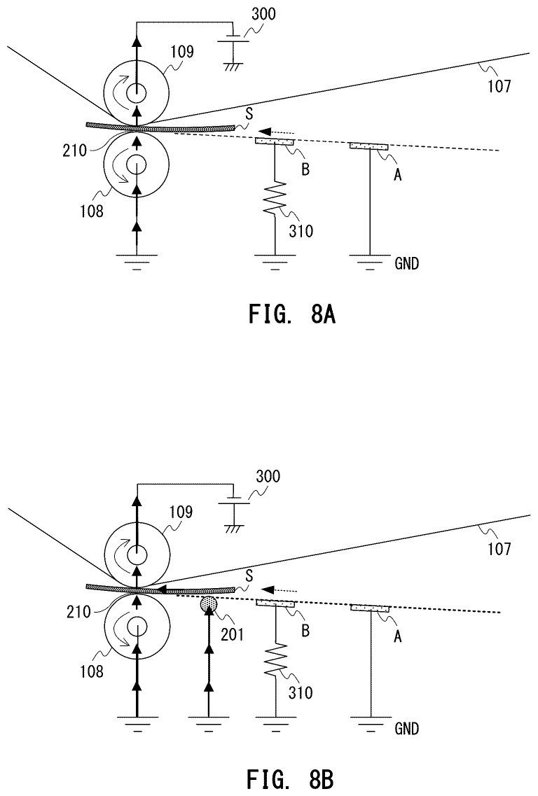

The image forming apparatus 100 may use paper other than metalized paper, for example, plain paper and thin paper which are light in basis weight, as the recording material S to form an image thereon. FIGS. 8A and 8B are explanatory diagrams of currents in the transfer of the toner images onto the recording material S that has a light basis weight such as plain paper or thin paper. The solid line arrows in FIGS. 8A and 8B indicate a path of currents (the non-passing portion current and the passing portion current) flowing in the secondary transfer unit TR2. The broken line arrows indicate the conveyance direction of the recording material S (plain paper or thin paper). Thin paper is lighter in self-weight than a recording material that has a heavy basis weight such as metalized paper. Accordingly, the recording material S that is thin paper may be warped around the rear end of the recording material S in the conveyance direction from being nipped by the nip portion 210.

FIG. 8A is a diagram of a configuration of the related art in which the contact member 201 is not provided. In this configuration, even when the warping of the recording material S occurs, a current path is uniquely determined to run in a direction indicated by the arrows, and fluctuations of the passing portion current are accordingly small.

FIG. 8B is a diagram of a configuration provided with the contact member 201 as in the first embodiment. The warping causes the recording material S to lose contact with the contact member 201. For that reason, the current path in the secondary transfer unit TR2 differs between a state in which the recording material S is in contact with the contact member 201 and a state in which the recording material S is away from the contact member 201. That is, the load impedance viewed from the secondary transfer unit TR2 changes. As a result, fluctuations of the passing portion current increase to cause deterioration of transfer properties of the toner images onto the recording material S.

To summarize, in a case of transfer of the toner images onto a recording material having a basis weight that exceeds a predetermined value, the transfer properties are maintained better by the configuration provided with the contact member 201. In a case of transfer of the toner images onto a recording material having a light basis weight, the transfer properties are maintained better by the configuration in which the contact member 201 is not provided. Accordingly, the first embodiment employs the configuration illustrated in FIG. 2 with which the transfer properties of the toner images are maintained irrespective of the basis weight of the recording material S.

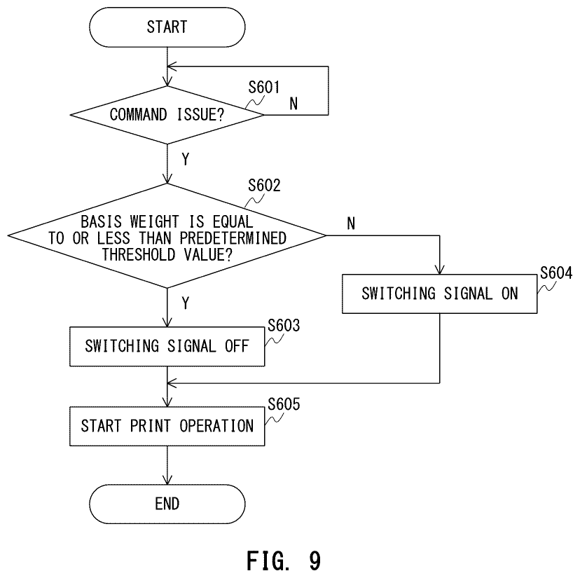

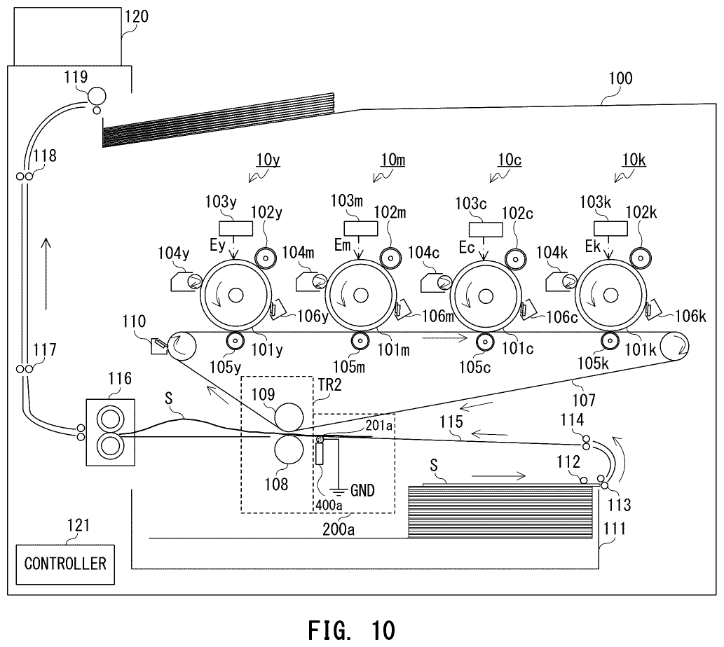

FIG. 9 is a flow chart for illustrating a variation of the processing in image forming. This processing differs from the processing of FIG. 7 in a determination criterion used by the controller 121 in inputting the switching signal to the switching unit 400. This processing is for transferring the toner images onto the recording material S without causing defective transfer irrespective of the basis weight of the recording material S.

As the image forming apparatus 100 starts to operate, the controller 121 checks whether a command of a print job has been acquired from the operation unit 120 of the image forming apparatus 100, or from an external apparatus via a network (Step S601). In a case where the command has not been acquired (Step S601: N), the controller 121 stands by until the command is acquired.

In a case in which the command has been acquired (Step S601: Y), the controller 121 checks the basis weight of the recording material S stored in the sheet feeding cassette 111 that is specified by the print job, and compares the basis weight to a predetermined value (predetermined threshold value) (Step S602). Based on a result of the comparison between the basis weight and the predetermined threshold value, the controller 121 controls input of the switching signal to the switching unit 400. The basis weight of the recording material S is checked from, for example, setting values that are set by the user with use of the operation unit 120 in a case where the recording material S is stored in the sheet feeding cassette 111. The setting values include, for example, feature information (basis weight, size, and the like) of the recording material S. An example of the recording material S that has a basis weight equal to or less than the predetermined threshold value is thin paper. An example of the recording material S that has a basis weight exceeding the predetermined threshold value is metalized paper.

In a case where the basis weight of the recording material S is found out to be, for example, equal to or less than the predetermined threshold value as a result of the comparison (Step S602: Y), the controller 121 turns off the switching signal to the switching unit 400 (the switching signal is not output) (Step S603). In a case where the basis weight of the recording material S is found out to be, for example, more than the predetermined threshold value as a result of the comparison (Step S602: N), the controller 121 turns on the switching signal to the switching unit 400 (the switching signal is output) (Step S604). The output of the switching signal to the switching unit 400 establishes conduction for the switching unit 400, with the result that the contact member 201 is grounded. After controlling the switching unit 400, the controller 121 starts print operation in order to form an image in accordance with the print job (Step S605). In a case where print operation instructed by the print job is finished, the controller 121 ends a series of processing steps in image forming that is suited to the print job.

The image forming apparatus 100 thus switches the grounding state of the contact member 201 within the pre-transfer contact unit 200 between grounded and ungrounded depending on the basis weight of the recording material S. Specifically, the contact member 201 is grounded in a case where the basis weight of the recording material S exceeds a predetermined threshold value, and is ungrounded in a case where the basis weight is equal to or less than the predetermined threshold value. Accordingly, in a case where the recording material S has a basis weight exceeding the predetermined threshold value, a current flows in the contact member 201 to suppress fluctuations of the passing portion current. In a case where the recording material S has a basis weight equal to or less than the predetermined threshold value, currents flow in the secondary transfer outer roller 108 to suppress fluctuations of the passing portion current. With fluctuations of the passing portion current thus suppressed, stable transfer of the toner images is achieved irrespective of the basis weight of the recording material S that is passed through.

The image forming apparatus 100 may combine the processing of FIG. 7 with the processing of FIG. 9 in executing print operation. That is, the grounding state of the contact member 201 may be switched between grounded and ungrounded based on whether the recording material S is metalized paper and on a result of comparison between the basis weight of the recording material S and a predetermined threshold value.

As described above, the image forming apparatus 100 controls the grounding state (grounded/ungrounded) of the contact member 201 based on the paper type (metalized paper or other than metalized paper, the basis weight) of the recording material S, to thereby achieve stable transfer of the toner images onto the recording material S. The contact member 201 has a configuration that brings the contact member 201 into contact with one surface (the surface on the opposite side from the surface onto which the toner images are to be transferred) of the recording material S, but may have a configuration that brings the contact member 201 into contact with the opposite-side surface (the surface on the side on which the toner images are to be transferred) of the recording material S. The contact member 201 may be, other than the columnar metal member, a metallic string such as a wire or a copper line. The contact member 201 has a configuration that brings the contact member 201 into contact with the recording material S in one or more places when the recording material S is nipped by the nip portion 210. The portion(s) of contact may have any one of a dot-shape, a linear shape, and a planar shape.

The configuration of the switching unit 400 described with reference to FIG. 4 includes a relay. However, the switching unit 400 is not limited thereto. For example, the switching unit 400 may be configured with use of a semiconductor switch element. In this case, a conduction state (conductive/non-conductive) of the semiconductor switch element is switched by the switching signal. The semiconductor switch element may be, for example, a Metal Oxide Semiconductor Field Effect Transistor (MOSFET) or an Insulated Gate Bipolar Transistor (IGBT).

Although a configuration in which the toner images are transferred onto the recording material S by the secondary transfer unit TR2 is described in the first embodiment, the first embodiment is effective also for a case in which the toner images are transferred onto the recording material S directly from the photosensitive drums 101y, 101m, 101c, and 101k. For example, some of image forming apparatus that form a monochromatic image have a configuration in which a toner image is transferred onto the recording material S directly from a photosensitive drum. Some of image forming apparatus that form a color image are also configured so as to transfer toner images onto the recording material S directly from a photosensitive drum by forming toner images of different colors on a single photosensitive drum one color at a time. The photosensitive drum and a primary transfer roller form a nip portion in which the toner image or the toner images are transferred onto the recording material S.

In this case, the contact member 201 is provided on a side upstream of the photosensitive drum in a conveyance direction of the recording material S. In a case where the recording material S is of a paper type that has adverse effects on the transfer of the toner image(s) unless the recording material S is grounded by the contact member 201, the controller 121 grounds the recording material S by establishing conduction for the switching unit 400 with use of the switching signal.

### Second Embodiment

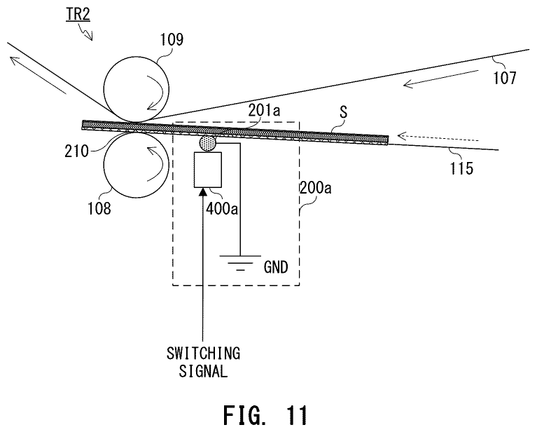

FIG. 10 is a configuration diagram of an image forming apparatus according to a second embodiment of the present disclosure. The image forming apparatus of FIG. 10 differs from the image forming apparatus 100 according to the first embodiment which is illustrated in FIG. 1 in configuration of a pre-transfer contact unit 200a, and is the same as the image forming apparatus 100 in configurations of other parts. Here, the different configuration is described, and description on the same configurations is omitted.

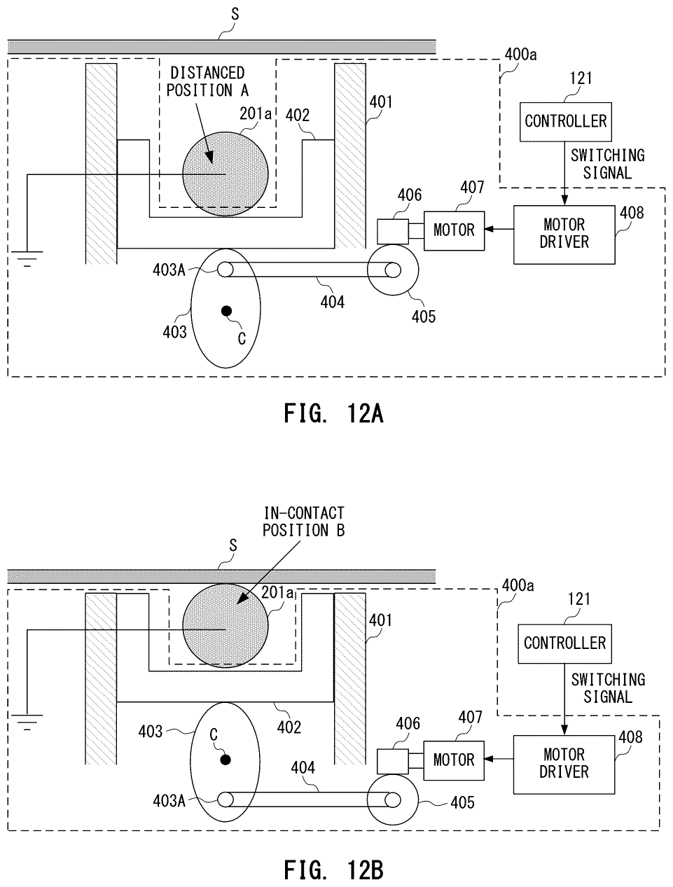

The pre-transfer contact unit 200a is provided on a side upstream of the secondary transfer unit TR2 in the conveyance direction of the recording material S. FIG. 11 is an explanatory diagram of a configuration of the pre-transfer contact unit 200a. The solid line arrows of FIG. 11 indicate a rotation direction of the intermediate transfer belt 107 and rotation directions of the secondary transfer outer roller 108 and the secondary transfer inner roller 109 in transfer of the toner images onto the recording material S. The broken line arrow indicates a conveyance direction of the recording material S.

The pre-transfer contact unit 200a includes a contact member 201a and a switching unit 400a. The contact member 201a is a conductive member and is grounded. The switching unit 400a places the contact member 201a at one of a position (a second position) at which the contact member 201a comes into contact with one surface (a surface on an opposite side from a surface onto which the toner images are to be transferred) of the recording material S having been conveyed from the guide member 115, and a position (a first position) at which the contact member 201a does not come into contact with the one surface, based on the switching signal. The switching signal is transmitted from the controller 121. A detailed configuration of the switching unit 400a is described later. The contact member 201a is placed so as to come into contact with one or more places of the recording material S when the recording material S comes into contact with the secondary transfer outer roller 108.

In the second embodiment, the bias voltage is controlled by constant-voltage control as in the first embodiment. Further, in order to prevent an electric discharge from occurring between the secondary transfer outer roller 108 and the contact member 201a when the bias voltage is applied to the secondary transfer inner roller 109, the contact member 201a is placed at a predetermined distance or farther from the secondary transfer outer roller 108.

Similarly to the contact member 201 in the first embodiment, the contact member 201a has a columnar shape, and an axis direction thereof runs along the width direction. In order to suppress fluctuations in load impedance of the secondary transfer unit TR2, it is preferred that the length of the contact member 201a in the width direction be longer than the length of the recording material S of a maximum size allowed to be used in this image forming apparatus (the size A3) in the width direction.

A material of the contact member 201a may be a member having lower impedance than that of the guide member 115 and, in the second embodiment, the contact member 201a is formed from, for example, a metal member. With this configuration, the load impedance viewed from the secondary transfer unit TR2 can be stabilized irrespective of the location of the recording material S that is being conveyed.

FIGS. 12A and 12B are explanatory diagrams of the switching unit 400a. The switching unit 400a includes a guide frame 401 equipped with a support member 402 inside, and a moving mechanism which uses the support member 402 to move the contact member 201a. The moving mechanism includes a cam 403, a power transmission belt 404, a driven gear 405, a driving gear 406, a motor 407, and a motor driver 408.

The guide frame 401 has two wall portions provided so as to sandwich the support member 402 in the conveyance direction of the recording material S. The support member 402 supports the contact member 201a between the two wall portions of the guide frame 401. The support member 402 is movable along the guide frame 401 to a conveyance path side (a top-and-bottom direction in FIGS. 12A and 12B). The moving of the support member 402 enables the contact member 201a to move in a direction in which the contact member 201a approaches the conveyance path and a direction in which the contact member 201a travels away from the conveyance path.

The motor 407 is a drive source for moving the contact member 201a, and is driven by the motor driver 408. A drive force output from the motor 407 is transmitted to the cam 403 via the driving gear 406, the driven gear 405, and the power transmission belt 404. The cam 403 is a rotating cam member, has an elliptical shape in section in a direction perpendicular to a rotation axis of the cam 403, and has a rotation center axis 403A parallel to a longitudinal direction of the contact member 201a. The rotation center axis 403A is positioned offset from a center C of the elliptical shape of the cam 403. The cam 403 is a rotating member that rotates about the rotation center axis 403A by an amount corresponding to the transmitted drive force. The cam 403 comes into contact with a bottom surface of the support member 402, and maintains the contact during rotation, to thereby cause the support member 402 to move reciprocally in the top-and-bottom direction along the guide frame 401. The up-and-down movement of the support member 402 controls a contact state (in contact/out of contact) of the contact member 201a regarding contact with the recording material S.

The controller 121 transmits the switching signal to the motor driver 408, to thereby move the contact member 201a between an in-contact position and a distanced position. The in-contact position is a position at which the contact member 201a comes into contact with the recording material S being conveyed on the conveyance path, and is a position at which the contact member 201a grounds the recording material S. The distanced position is a position at which the contact member 201a having retreated from the conveyance path is out of contact with the recording material S, and is a position at which the contact member 201a does not ground the recording material S. The switching signal takes two values of different levels. In a case where the switching signal has one of the two values (a high level), the motor driver 408 drives the motor 407 in a manner that places the contact member 201a at the in-contact position. This enables the contact member 201a to come into contact with the recording material S. In a case where the switching signal has another of the two values (a low level), the motor driver 408 drives the motor 407 in a manner that places the contact member 201a at the distanced position. This stops the contact member 201a from coming into contact with the recording material S.

FIG. 12A is an illustration of a state in which the support member 402 has moved away from the conveyance path to place the contact member 201a at a position (distanced position A) at which the contact member 201a is not in contact with the recording material S being nipped by the nip portion 210. FIG. 12B is an illustration of a state in which the support member 402 has moved close to the conveyance path to place the contact member 201a at a position (in-contact position B) at which the contact member 201a is in contact with the recording material S being nipped by the nip portion 210. The contact member 201a can thus be placed at one of a first position (the distanced position A) at which the contact member 201a is not in contact with the recording material S and a second position (the in-contact position B) at which the contact member 201a is in contact with the recording material S, depending on a manner in which the cam 403 rotates.

The rotation center axis 403A may be at the same position as the center C as long as the cam 403 has an elliptical shape in section in the direction perpendicular to the rotation axis. In this case, the contact member 201a is placed at the in-contact position B when a portion along a major axis of the cam 403 is in contact with the guide frame 401, and the contact member 201a is placed at the distanced position A when a portion along a minor axis of the cam 403 is in contact with the guide frame 401. The cam 403 may also have a circular shape in section in the direction perpendicular to the rotation axis, and have a configuration in which the rotation center axis 403A is positioned offset from the center C. In this case, the contact member 201a is placed at the in-contact position B when a portion of the cam 403 that is farthest from the rotation center axis 403A is in contact with the guide frame 401, and the contact member 201a is placed at the distanced position A when a portion of the cam 403 that is closest to the rotation center axis 403A is in contact with the guide frame 401. Instead of the configuration in which the cam 403 rotates, a cam configured to move in a one-dimensional direction may be used as the cam 403.

The thus configured image forming apparatus 100 is capable of forming an image on the recording material S that includes a metal layer such as the metalized paper described with reference to FIG. 5. In addition, as described with reference to FIG. 6, the transfer properties of the toner images are maintained by providing the contact member 201a between the guide member B and the secondary transfer outer roller 108 and thereby stabilizing the current flowing to the recording material S.

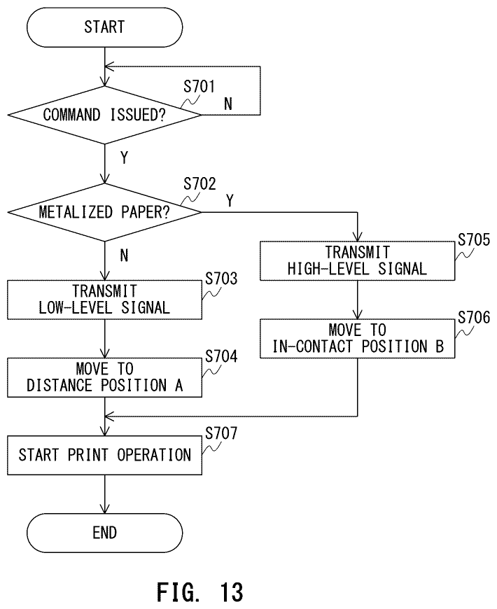

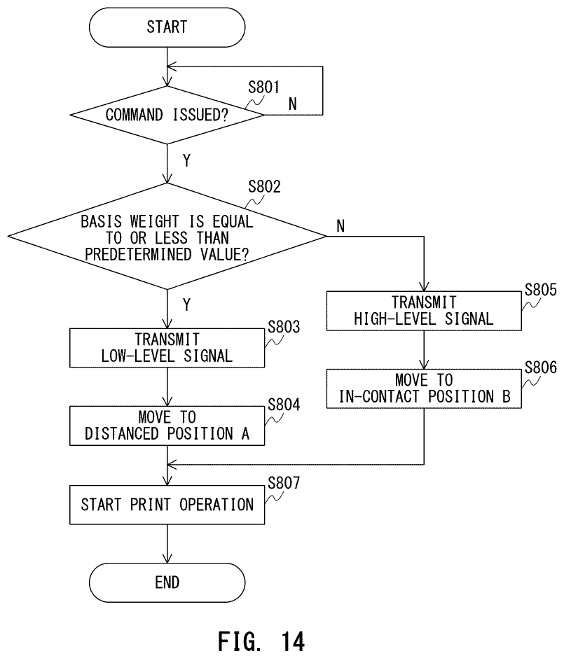

FIG. 13 is a flow chart for illustrating processing in image forming. This processing is for transferring the toner images onto the recording material S without causing defective transfer irrespective of the paper type of the recording material S.

As the image forming apparatus 100 starts to operate, the controller 121 checks whether a command of a print job has been acquired from the operation unit 120 of the image forming apparatus 100, or from an external apparatus via a network (Step S701). In a case where the command has not been acquired (Step S701: N), the controller 121 stands by until the command is acquired.

In a case where the command has been acquired (Step S701: Y), the controller 121 checks a paper type of the recording material S that is stored in the sheet feeding cassette 111 and that is specified in the print job, and determines whether the recording material S is metalized paper (Step S702) or not. The paper type of the recording material S is checked by, for example, referring to setting values that are set by the user with use of the operation unit 120 when the recording material S is stored in the sheet feeding cassette 111. The setting values include, for example, feature information (paper type, size, and the like) of the recording material S.

In the case in which the recording material S is a recording material that is other than metalized paper and that has high impedance, for example, plain paper (Step S702: N), the recording material S does not need to be grounded by the contact member 201a. The controller 121 accordingly transmits the switching signal that is at a first level (low level) to the switching unit 400a, and thereby causes the switching unit 400a to move the contact member 201a to the distanced position A (see FIG. 12A) (Step S703 and Step S704). The switching signal at the first level is a control signal for placing the contact member 201a at the distanced position A. With the contact member 201a not being in contact with the recording material S, the recording material S is ungrounded.

In the case in which the recording material S is metalized paper that has low impedance (Step S702: Y), the recording material S may be grounded by the contact member 201a. The controller 121 accordingly transmits the switching signal that is at a second level (high level) to the switching unit 400a, and thereby causes the switching unit 400a to place the contact member 201a at the in-contact position B (see FIG. 12B) (Step S705 and Step S706). The switching signal at the second level is a control signal for placing the contact member 201a at the in-contact position B. With the contact member 201a being in contact with the recording material S, the recording material S is grounded.

After moving the contact member 201a to the distanced position A or the in-contact position B, the controller 121 starts print operation in order to form an image in accordance with the print job (Step S707). In a case where print operation instructed by the print job is finished, the controller 121 ends a series of processing steps in image forming that is suited to the print job.

In this manner, the image forming apparatus 100 according to the second embodiment switches the position of the contact member 201a within the pre-transfer contact unit 200a between the distanced position A and the in-contact position B depending on the paper type of the recording material S. Specifically, the contact member 201a is placed at the in-contact position B and is accordingly in contact with the recording material S in a case where the recording material S is of the first paper type (for example, metalized paper), and, in a case where the recording material S is of the second paper type higher in impedance than the first paper type, the contact member 201a is placed at the distanced position A and is accordingly not in contact with the recording material S. Accordingly, in a case where the recording material S is of the first paper type, a current flows in the contact member 201a to suppress fluctuations of the passing portion current. In a case where the recording material S is of the second paper type, currents flow in the secondary transfer outer roller 108 to suppress fluctuations of the passing portion current. With fluctuations of the passing portion current thus suppressed, stable transfer of the toner images is achieved irrespective of the paper type of the recording material S that is passed through.

### Modification Example of Second Embodiment

The example given above is a configuration that suppresses fluctuations of the passing portion current by switching whether to bring the contact member 201a into contact with the recording material S depending on the paper type of the recording material S. In this example, fluctuations of the passing portion current are suppressed by switching whether to bring the contact member 201a into contact with the recording material S depending on the basis weight of the recording material S.

The image forming apparatus 100 may use paper other than metalized paper, for example, thin paper which is light in basis weight, as the recording material S to form an image thereon. As described in the modification example of the first embodiment, the recording material S that has a light basis weight such as plain paper or thin paper may be warped around the rear end of the recording material S in the conveyance direction from being nipped by the nip portion 210. Accordingly, in a case of transfer of the toner images onto a recording material having a basis weight that exceeds a predetermined value, the transfer properties are maintained better by the configuration provided with the contact member 201a. In a case of transfer of the toner images onto a recording material having a light basis weight, the transfer properties are maintained better by the configuration in which the contact member 201a is not provided.

FIG. 14 is a flow chart for illustrating a variation of the processing in image forming. This processing differs from the processing of FIG. 13 in a determination criterion used by the controller 121 in inputting the signal to the switching unit 400a. This processing is for transferring the toner images onto the recording material S without causing defective transfer irrespective of the basis weight of the recording material S.

As the image forming apparatus 100 starts to operate, the controller 121 checks whether a command of a print job has been acquired from the operation unit 120 of the image forming apparatus 100, or from an external apparatus via a network (Step S801). In a case where the command has not been acquired (Step S801: N), the controller 121 stands by until the command is acquired.

In a case in which the command has been acquired (Step S801: Y), the controller 121 checks the basis weight of the recording material S stored in the sheet feeding cassette 111 that is specified by the print job, and compares the basis weight to a predetermined value (Step S802). Based on a result of the comparison between the basis weight and the predetermined value, the controller 121 controls input of the switching signal to the switching unit 400a. The basis weight of the recording material S is checked from, for example, setting values that are set by the user with use of the operation unit 120 when the recording material S is stored in the sheet feeding cassette 111. The setting values include, for example, feature information (basis weight, size, and the like) of the recording material S. An example of the recording material S that has a basis weight equal to or less than the predetermined value is thin paper. An example of the recording material S that has a basis weight exceeding the predetermined value is metalized paper.

In a case where the basis weight of the recording material S is found out to be, for example, equal to or less than the predetermined value as a result of the comparison (Step S802: Y), the recording material S does not need to be grounded by the contact member 201a. Accordingly, as in the processing steps of Step S703 and Step S704 of FIG. 13, the controller 121 transmits the switching signal that is at the first level (low level) to the switching unit 400a, and thereby causes the switching unit 400a to place the contact member 201a at the distanced position A (see FIG. 12A) (Step S803 and Step S804).

In a case where the basis weight of the recording material S is found out to be, for example, larger than the predetermined value as a result of the comparison (Step S802: N), the recording material S may be grounded by the contact member 201a. Accordingly, as in the processing steps of Step S705 and Step S706 of FIG. 13, the controller 121 transmits the switching signal that is at the second level (high level) to the switching unit 400a, and thereby causes the switching unit 400a to place the contact member 201a at the in-contact position B (see FIG. 12B) (Step S805 and Step S806).

After placing the contact member 201a at the distanced position A or the in-contact position B, the controller 121 starts print operation in order to form an image in accordance with the print job (Step S807). In a case where print operation instructed by the print job is finished, the controller 121 ends a series of processing steps in image forming that is suited to the print job.

In this manner, the image forming apparatus 100 according to the second embodiment switches the position of the contact member 201a within the pre-transfer contact unit 200a between the distanced position A and the in-contact position B depending on the basis weight of the recording material S. Specifically, in a case where the basis weight of the recording material S exceeds a predetermined value, the contact member 201a is placed at the in-contact position B and is accordingly in contact with the recording material S. In a case where the basis weight is equal to or less than the predetermined value, the contact member 201a is placed at the distanced position A and is accordingly not in contact with the recording material S. Accordingly, in a case where the recording material S has a basis weight exceeding the predetermined value, a current flows in the contact member 201a to suppress fluctuations of the passing portion current. In a case where the recording material S has a basis weight equal to or less than the predetermined value, currents flow in the secondary transfer outer roller 108 to suppress fluctuations of the passing portion current. With fluctuations of the passing portion current thus suppressed, stable transfer of the toner images is achieved irrespective of the basis weight of the recording material S that is passed through.

As described above, the image forming apparatus 100 controls the position of the contact member 201a based on the paper type (metalizedpaper or other than metalized paper, the basis weight) of the recording material S, to thereby achieve stable transfer of the toner images onto the recording material S. In the example described above, the contact member 201a has a configuration of being in contact with one surface (the surface on the side on which the toner images are not to be transferred) of the recording material S, but may have a configuration of being in contact with the opposite-side surface (the surface on the side on which the toner images are to be transferred) of the recording material S. The contact member 201a may be, other than the columnar metal member, a metallic string such as a wire or a copper line. The contact member 201a has a configuration of being in contact with the recording material S in one or more places when the recording material S is nipped by the nip portion 210. The portion(s) of contact may have any one of a dot-shape, a linear shape, and a planar shape.

The switching unit 400a has, in FIG. 12A and FIG. 12B, a configuration including the support member 402, the guide frame 401, the cam 403, the motor 407, the motor driver 408, and a mechanism for transmitting the drive force, but is not limited thereto. The switching unit 400a may have any configuration that enables the contact member 201a to switch the position thereof between the distanced position A and the in-contact position B.

Although a configuration in which the toner images are transferred onto the recording material S by the secondary transfer unit TR2 is described in the second embodiment, the second embodiment is effective also for a case in which the toner images are transferred onto the recording material S directly from the photosensitive drums 101y, 101m, 101c, and 101k. For example, some of image forming apparatus that form a monochromatic image have a configuration in which a toner image is transferred onto the recording material S directly from a photosensitive drum. Some of image forming apparatus that form a color image are also configured so as to transfer toner images onto the recording material S directly from a photosensitive drum by forming toner images of different colors on a single photosensitive drum one color at a time. The photosensitive drum and a primary transfer roller form a nip portion in which the toner image or the toner images are transferred onto the recording material S.

In this case, the contact member 201a is provided on a side upstream of the photosensitive drum in a conveyance direction of the recording material S. In a case where the recording material S is of a paper type that has adverse effects on the transfer of the toner image(s) unless the recording material S is grounded by the contact member 201a, the controller 121 grounds the recording material S by establishing conduction for the switching unit 400a with use of the switching signal.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of priority from Japanese Patent Applications No. 2024-140649, filed Aug. 22, 2024, and No. 2024-140652, filed Aug. 22, 2024, which are hereby incorporated by reference herein in their entirety.

What is claimed is:

1. An image forming apparatus comprising:
an image bearing member;
an image former configured to form an image on the image bearing member;
a transfer portion configured to transfer the image formed on the image bearing member onto a recording material;
a conveyor configured to convey the recording material to the transfer portion;
a contact portion provided upstream of the transfer portion in a conveyance direction of the recording material and comprising a contact member for grounding the recording material to be conveyed to the transfer portion; and
at least one processor configured to control, in a case where the recording material is of a first paper type, the contact portion so that the recording material is grounded by the contact member, and control, in a case where the recording material is of a second paper type higher in impedance than the first paper type, the contact portion so as to avoid grounding the recording material.

2. The image forming apparatus according to claim 1, wherein the at least one processor is configured to ground the recording material by controlling the contact portion so that the contact member is grounded and is in contact with the recording material.

3. The image forming apparatus according to claim 1, wherein the first paper type is metalized paper comprising a metal layer.

4. The image forming apparatus according to claim 1, wherein the first paper type is heavier in basis weight than the second paper type.

5. The image forming apparatus according to claim 1,
wherein the contact portion includes a switch device configured to switch a grounding state of the contact member between grounded and ungrounded, and
wherein the at least one processor is configured to control the switch device so that the grounding state of the contact member is switched.

6. The image forming apparatus according to claim 5, wherein the switch device includes a switch provided between the contact member and a ground.

7. The image forming apparatus according to claim 6, wherein the switch is configured from a relay.

8. The image forming apparatus according to claim 6, wherein the switch is configured from a semiconductor switch element.

9. The image forming apparatus according to claim 1,
wherein the contact portion includes a mover configured to move the contact member to a first position at which the contact member is out of contact with the recording material conveyed to the transfer portion, and a second position at which the contact member is in contact with the recording material conveyed to the transfer portion, and
wherein the at least one processor is configured to control, in a case where the recording material is of the first paper type, the mover so that the contact member is moved to the second position, and to control, in a case where the recording material is of the second paper type, the mover so that the contact member is moved to the first position.

10. The image forming apparatus according to claim 9, wherein the mover includes a cam member for moving the contact member to the first position and the second position.

11. The image forming apparatus according to claim 10, wherein the contact member is grounded in both of a state in which the contact member is moved to the first position and a state in which the contact member is moved to the second position.

12. The image forming apparatus according to claim 1,
wherein the conveyor is configured to convey the recording material to the transfer portion via a guide member, and
wherein the contact member is a member lower in impedance than the guide member.

13. The image forming apparatus according to claim 1, wherein the contact portion is configured to come into contact with a surface of the recording material that is on an opposite side from a surface onto which an image is to be transferred by the transfer portion.

14. The image forming apparatus according to claim 1, wherein the contact portion is configured to come into contact with a surface of the recording material onto which an image is to be transferred by the transfer portion.
